(19) United States
(12) Patent Application Publication
(10) Pub. No.: US 2022/0258548 A1
(43) Pub. Date: Aug. 18, 2022

(54) VEHICLE TIRE ASSEMBLY INCLUDING AN INTERNAL INFLATION HEIGHT AND CONTACT PATCH SENSOR USING MILLIMETER WAVELENGTH RADAR

(71) Applicant: Firestone Industrial Products Company, LLC, Nashville, TN (US)

(72) Inventor: Daniel L. Nordmeyer, Largo, FL (US)

(21) Appl. No.: 17/627,448

(22) PCT Filed: Jul. 15, 2020
(86) PCT No.: PCT/US2020/042039

§ 371 Date: Jan. 14, 2022

Related U.S. Application Data
(60) Provisional application No. 62/874,326, filed on Jul. 15, 2019.

(51) Int. Cl. B60C 23/06; B60C 23/08; H01Q 1/22; G06T 7/62; G01S 13/06; G01B 15/02; G01S 13/58

(52) U.S. Cl. CPC B60C 23/064; B60C 23/08; H01Q 1/2241; G06T 2207/30252; G01S 13/06; G01B 15/02; G01S 13/584; G06T 7/62

(57) ABSTRACT

A tire assembly includes a tire and a tire height and contact patch sensor at least partially disposed within a tire chamber of the tire. The sensor includes a radar source operable to direct millimeter wave radar waves in the range of 120 to 240 gigahertz (GHz) toward an inner surface of the tire. The sensor also includes a radar receptor operable to generate a signal upon receiving the reflected radar waves. A processor is operable to determine a distance between the radar source and a target based upon at least one of: (i) a time of flight; (ii) a frequency phase shift. The sensor includes an antenna for transmitting data to a system external to the tire chamber. The processor optionally determines dimensions of the tire contact patch and/or can generate an image of the tire contact patch for image pattern matching to determine inflation and/or load state of the tire.

### BACKGROUND

The subject matter of the present disclosure broadly relates to the art of vehicle tire assemblies that include internal inflation height and contact patch sensors operative to generate signals, data, information and/or other outputs having a relation to an inflated height of the associated tire assembly and/or having a relation to the contact patch defined between the tread of the associated tire assembly and a roadway or other support surface on which the tire assembly is supported. Such sensors use millimeter wave radar technology of an predetermined frequency and wavelength and/or within a predetermined range of frequencies and wavelengths. Tire assemblies including such millimeter wavelength radar inflation height and contact patch sensors as well vehicle systems including one or more of such tire assemblies are also included.

It will be appreciated that the subject matter of the present disclosure may be particularly amenable to use in connection with vehicles, including motorized vehicles such as cars, trucks, and buses and also unmotorized vehicles such as trailers or the like, and the subject matter hereof will be discussed in detail with specific reference to such vehicles. However, it is to be specifically understood that application and use of the subject sensors is not intended to be in any way limited to the specific examples disclosed herein, which are merely exemplary.

It is generally known to include one or more sensors inside of a tire body and/or as part of a tire assembly, such as connected to a wheel and located in an air chamber of a pneumatic tire. Such sensors have included optical sensors, ultrasonic sensors, and other non-contact distance sensors. In many cases, such system have been deemed to be suboptimal for a wide variety of different reasons such as low resolution, slow update and/or refresh rates, ineffectiveness due to the conditions inside the tire chamber, and other drawbacks such as the inability to derive the data needed for use in modern vehicle control systems.

One such prior system uses an ultrawideband radar sensor inside of a tire chamber. The sensor uses radar waves to sense the condition of the soil beneath the tire, to sense the tire footprint, and/or to sense deflection of the tire casing. The ultrawideband radar waves are thought to be deficient in terms of the type, quality and speed of the data provided in terms of resolution, refresh rates, electronic interference, and the like. Also, one such prior system uses a slip ring to install the sensor such that it is continuously oriented vertically downward toward the surface on which the tire is rolling, and this slip ring system is not desirable for many applications due to a variety of know deficiencies.

Other known sensors are embedded in the casing of the tire, such as in the tread region or sidewall. These sensors can be effective for certain applications but require the tire, itself, to be manufactured with or modified to include the sensor(s), which increases the cost of the tires and prevents the re-use of sensors that are permanently embedded in the tire casing. These systems typically also lack a source of electrical power and require a fixed radio-frequency interrogator connected to the vehicle body or suspension to energize and activate the sensor.

Still other systems have relied upon placement of sensors external to the tire air chamber, such as on the vehicle suspension or body. Such systems attempt to sense the conditions inside the tire from outside the tire casing, which reduces their effectiveness and limits the type and quality of information provided.

Notwithstanding these conventional tire sensors and others that are known in the art, it is believed that a need exists to address the foregoing and/or other challenges while providing comparable or improved performance, ease of manufacture, reduced cost of manufacture, and/or otherwise advancing the art of tire assemblies and sensors for same.

### BRIEF SUMMARY

One example of a tire assembly in accordance with the subject matter of the present disclosure can include a tire with a tire body that includes a cylindrical tread region and axially-spaced first and second sidewalls extending radially inward to respective first and second mounting beads that at least partially define a central opening of the tire body. The tire body can include an inner surface, and the cylindrical tread region can include an exterior tread adapted to roll along an associated road surface. The cylindrical tread region together with the first and second sidewalls can at least partially define an annular tire chamber with an open end in communication with the central opening of the tire body. A tire height and contact patch sensor can be at least partially disposed within the annular tire chamber. The sensor can include an electrical power source and a radar source communicatively coupled with the electrical power source. The radar source can be operable to emit millimeter wavelength radar waves into the annular tire chamber toward a target area along the inner surface of the tire body. A radar receptor can be communicatively coupled with the electrical power source and operable to receive millimeter wavelength radar waves reflected off of the target area along the inner surface of the tire body. The radar receptor can also be operable to generate a signal having a relation to the reflected radar waves and/or receipt of the reflected radar waves at the radar receptor, such as in relation to a time of arrival, for example. An antenna can be communicatively coupled with at least the radar receptor and operable to transmit data, signals and/or communications having the relation to the reflected radar waves and/or receipt of the reflected radar waves at the radar receptor to an associated system external to the annular tire chamber. A processor can be communicatively coupled with at least one of the radar source, the radar receptor and the antenna. The processor can be operable to determine a distance between the radar source and the target area based on at least one of: (i) a time of flight required for the radar waves to travel from the radar source to the target area and then to the radar receptor; (ii) a frequency phase shift between the radar waves transmitted by the radar source and the radar waves reflected from the target area and received by the radar receptor.

One example of a vehicle system in accordance with the subject matter of the present disclosure can include an electronic control system, and at least one tire assembly according the foregoing paragraph in operative communication with the electronic control system.

### BRIEF DESCRIPTION OF THE DRAWINGS

FIG. 1 is a schematic representation of one example of a vehicle including a plurality of tire assemblies each including an inflation height and contact patch sensor in accordance with the subject matter of the present disclosure.

FIG. 2 is a schematic representation of a second example of a vehicle including a plurality of tire assemblies each including an inflation height and contact patch sensor in accordance with the subject matter of the present disclosure.

FIG. 3 is a cross-sectional side view of a tire assembly including an inflation height and contact patch sensor in accordance with the subject matter of the present disclosure.

FIG. 4 is a diagram showing changes tire contact patch in response to variations in tire air pressure and tire load.

FIG. 4A illustrates a two-dimensional image of a tire contact patch constructed by an inflation height and contact patch sensor for a tire assembly in accordance with an embodiment of the subject matter of the present disclosure.

FIG. 5 is a schematic representation of one example of an inflation height and contact patch sensor for a tire assembly in accordance with the subject matter of the present disclosure.

### DETAILED DESCRIPTION

Turning now to the drawings, it is to be understood that the showings are for purposes of illustrating examples of the subject matter of the present disclosure and are not intended to be limiting. Additionally, it will be appreciated that the drawings are not to scale and that portions of certain features and/or elements may be exaggerated for purpose of clarity and ease of understanding.

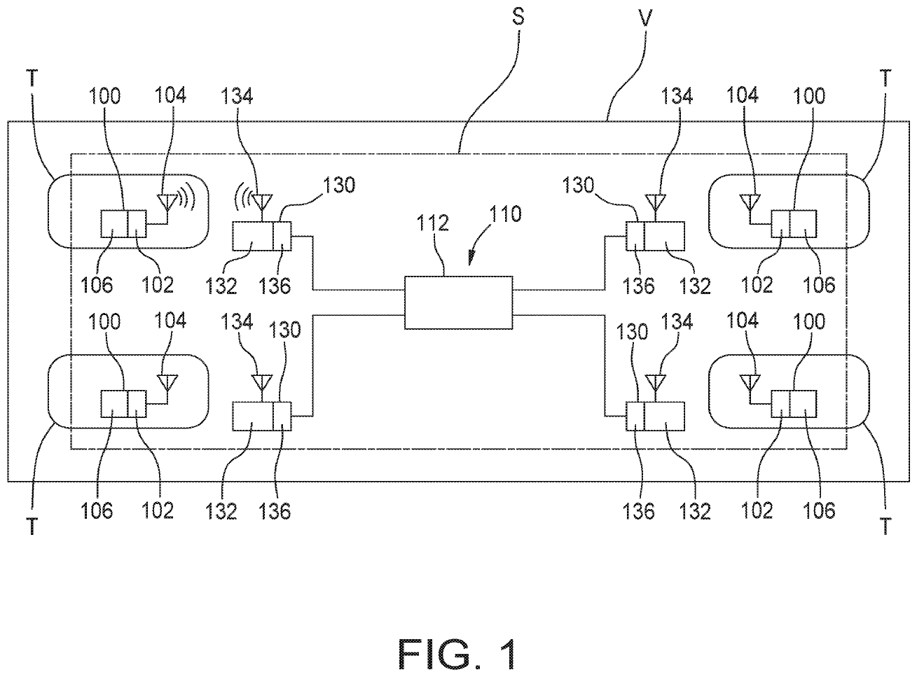

FIG. 1 is a schematic representation of one example of a vehicle V including a tire monitoring system S for monitoring tire inflation height and contact patch according to the present disclosure. Vehicle V can be a motorized vehicle, a towed or other non-motorized vehicle, or a combination of a motorized vehicle and non-motorized vehicle such as a tractor and semi-trailer vehicle. System S includes one or more pneumatic tire assemblies T that include an internal inflation height and contact patch sensor module or sensor 100 in accordance with the subject matter of the present disclosure, as described further below.

System S also includes an electronic control system 110 with an electronic control unit (ECU) 112 in operative communication with one or more of sensor modules 100 through respective receiver modules 130. In the embodiment illustrated in FIG. 1, sensor modules 100 and receiver modules 130 are provided in a 1:1 ratio with respect to each other, with each of receiver modules 130 being located on vehicle V in the region of tire assembly T with which it is respectively in communication. That is, in the exemplary arrangement shown, each receiver module 130 is located at a respective corner of vehicle V where a tire assembly T including a sensor module 100 is located. In such an exemplary arrangement, each receiver module 130 is in wireless operative communication with a respective one of sensor modules 100 via radio frequency or another wireless communication link. Receiver modules 130 are in wired (as shown) and/or wireless operative communication with ECU 112 for communication of power and data therebetween. In the embodiment of FIG. 1, sensor modules 100 thus include a sensor transceiver 102 and an antenna 104 connected to sensor transceiver 102 such that the sensor transceiver sends and receives wireless data to and from sensor module 100 (and optionally receives electrical power as described below) via RF signals sent and received using antenna 104. Sensor modules 100 also include an electronic controller or electronic processor 106, such as a microprocessor or the like, for controlling sensor 100 and for processing radar data as described herein. For example, as described in further detail below, processors 106 can derive information concerning the inflation height and contact patch of tire assembly T with which it is associated and communicate this information to ECU 112 for further processing and/or for use as control input to another system of vehicle V, such as, without limitation, warning lights or other warning systems, tire inflation/deflation systems, and/or any other systems and/or processes.

Receiver modules 130 include a receiver module transceiver 132 and an antenna 134 connected to transceiver 132 for bi-directional wireless data communication with (and optional power transmission to) a respectively associated sensor module 100 using wireless RF signals. In the embodiment shown in FIG. 1, receiver modules 130 also include a local electronic receiver processor 136, such as microprocessor or the like, for performing local data processing operations on sensor data received from the sensor module 100 with which a given receiver processor 136 is in communication. As such, receiver processor 136 of each receiver module 130 can use the data received from its respectively associated sensor module 100 to derive information concerning the inflation height and contact patch of tire assembly T and communicate this information to ECU 112 for further processing and/or for use as control input to another system of the vehicle V, such as, without limitation, a warning light or other warning system, a tire inflation/deflation system, and/or any other systems and/or processes. Alternatively, receiver processors 136 can be replaced by a single receiver processor provided by or as part of ECU 112 or other parts of electronic control system 110. ECU(s) 112, sensor processors 106, and receiver processors 136 can each be provided by any suitable type, kind and/or configuration, such as a microprocessor-based controller or other electronic controller, which can be separate or integrated into a single processor or module.

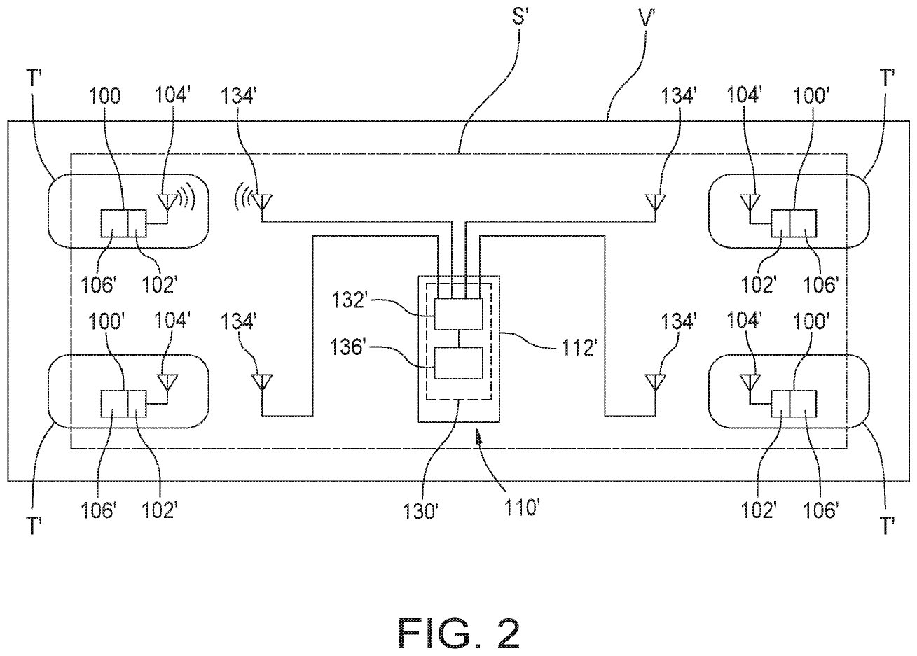

FIG. 2 is similar to FIG. 1 but shows vehicle V including an alternate tire monitoring system S′ that is identical to tire monitoring system S of FIG. 1 except as otherwise shown and/or described herein. Like components relative to the system S are identified with like reference characters including a primed (′) designation, and the description of some of these components is not repeated here. In the alternate arrangement illustrated in FIG. 2, each sensor module 100′ is in wireless communication with a single receiver module 130′ that is provided as part of or otherwise operatively connected to ECU 112′. Receiver module 130′ is in wireless operative communication with each sensor module 100′ via radio frequency or other wireless communication link. Receiver module 130′ includes a wireless transceiver 132′ and at least one antenna 134′ connected to transceiver 132′ for bi-directional wireless RF data communication between each sensor module 100′ and receiver module 130′. As shown in the present example, receiver module 130′ includes multiple antennae 134′, with each antenna dedicated to and preferably located in the region of one of tire sensor modules 100′, although receiver module 130′ alternatively uses only a single antenna 134′ to communicate with all of tire assembly sensor modules 100′. Receiver module 130′ includes an electronic receiver processor 136′, such as microprocessor or the like, for performing data processing operations on sensor data received from sensor modules 100′ with which it is in communication. As such, receiver processor 136′ can use the data received from sensor modules 100′ to derive information concerning the inflation height and contact patch of each tire assembly T′ and communicate this information to ECU 112′ for further processing and/or for use as control input to another system, device, or process of vehicle V′, such as a warning lights or other warning systems, tire inflation/deflation systems, and/or any other systems and/or processes. Alternatively, receiver processor 136′ can be provided by or as part of ECU 112′ or another part of electronic control system 110′.

In accordance with the subject matter of the present disclosure, each internal tire height and contact patch sensor 100 generates and outputs data, signals, information and/or other communications having a relation to the inflated height of the respective tire assembly with which it is operatively associated, and also optionally generates and outputs data, signals, information and/or other communications having a relation to the dimensions (e.g., size and shape) of a contact patch defined between the tread of tire assembly T and the roadway or other surface on which the tire assembly is supported for rolling thereon. Each tire inflation height and contact patch sensor 100 also can generate and output data, signals, information and/or other communications having a relation to the deflection of the sidewalls of a tire portion of tire assemblies T, a relation to an angle or change of angle between a target portion of the tire and sensor 100, and/or having a relation to the velocity and/or acceleration at which a portion of tire TR is moving relative to sensor S.

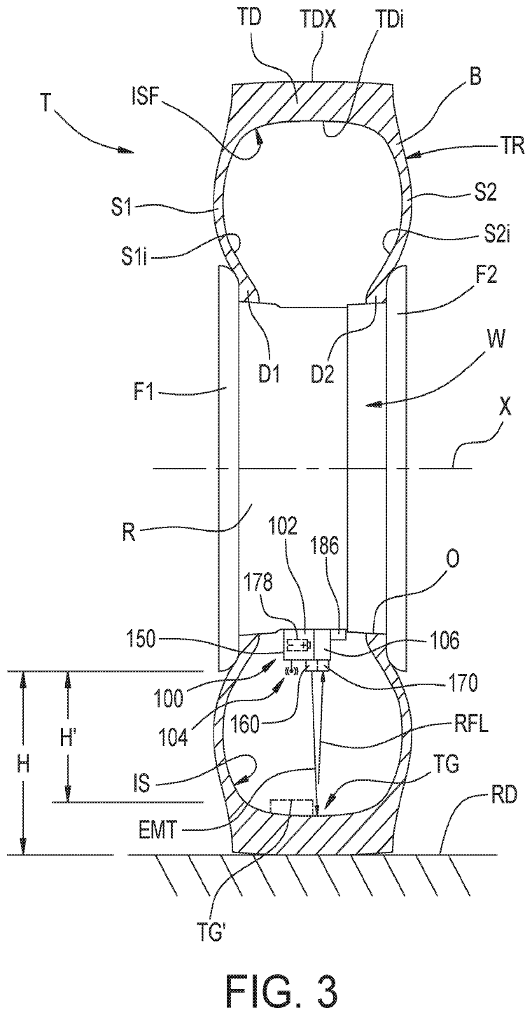

FIG. 3 is a cross-sectional side view of one example of tire assembly T including an inflation height and contact patch sensor in accordance with the subject matter of the present disclosure. Tire assembly T includes a one-piece or multi-piece wheel W that rotates about a rolling axis or axis of rotation X. Wheel W includes a cylindrical rim R defined concentrically about rolling axis X and on which an elastomeric pneumatically-inflated tire TR is operatively mounted. Rim R includes first and second circumferentially extending circular mounting flanges F1 and F2 that are axially spaced-apart along the rolling axis. Tire TR can include a reinforced elastomeric tire carcass or tire body B with a cylindrical tread region TD including an exterior tread TDX adapted to roll along a roadway or other associated support surface RD. Tire body B includes a central mounting opening O defined by first and second circular beads D1 and D2, which are connected to opposite inner and outer sides of tread region TD by way of first and second radially and circumferentially extending sidewalls S1 and S2, respectively. First and second beads D1 and D2 seat on the rim, respectively on or against first and second mounting flanges F1 and F2, and sealingly engage the flanges in an fluid-tight manner such that a hollow tire chamber C is defined between rim R and body B of tire TR. Tire body B includes an inner surface ISF that at least partially defines tire chamber C. Tire body inner surface ISF includes and is defined by first and second sidewall inner surfaces S1i and S2i of first and second sidewalls S1 and S2, respectively, and a tread region inner surface TDi that extends between and interconnects the first and second sidewall inner surfaces.

In a preferred arrangement, in accordance with the subject matter of the present disclosure, tire height and contact patch sensors 100 are located inside tire chamber C of tire assembly T and can be of a type, kind and/or construction that utilizes a radio wave (radar) transmitter operable to direct millimeter wavelength radar waves of a frequency greater than 120 gigahertz (GHz) and a wavelength of less than or equal to 2.5 millimeters (mm) toward a target surface inside tire chamber C. In one embodiment, sensor devices 100 transmit radar waves of a frequency in the range of 120 to 240 gigahertz (GHz), inclusively, corresponding to a wavelength in the range of 2.5 to 1.25 millimeters (mm), inclusively.

Sensing devices 100 further include a radar receptor that receives radar waves reflected off of the target surface and generates signals, data, information and/or communications that vary according the received reflected radar waves. Sensor devices 100 include a sensor processor 106 that utilizes the signals, data, information and/or communications generated by the radar receptor to derive a distance (sometimes referred to as “height” or “displacement”) between the radar source and the target surface which corresponds to a height or inflation height H of tire assembly T (or all of the same can be derived by each receiver processor 136).

Sensor processor 106 or receiver processor 136 optionally also derives the relative velocity and/or acceleration between the radar source and the target surface. Sensor processor 106 or receiver processor 136 also optionally derives an angle or change of angle between the radar source and the target surface. Processors 106 and/or 136 (or ECU 112) derive these and other operational data and information based upon at least one of: (i) the time of flight for a radar wave to travel from the radar source to the target and then to the radar receptor; (ii) a frequency shift (or “phase shift”) between the radar waves transmitted by the radar source and the radar waves reflected from the target surface and received by the radar receptor using a pulsed Doppler method or a continuous wave frequency modulation (CWFM) method; (iii) angle of arrival or change in angle of arrival of radar waves reflected from the target surface and received by the radar receptor. The distance derived by sensor processor 106 and/or receiver processor 136 has a relationship to the “inflation height” H (FIG. 3) of tire assembly T, which can be defined as the minimum radial distance between rim R and roadway RD or other surface on which tire assembly T is operably supported at any given time based upon the air pressure in chamber C and load carried by tire TR.

Tire assembly T is shown in FIG. 3 as including a tire inflation height and contact patch sensor 100 in accordance with the subject matter of the present disclosure. It will be appreciated that sensor 100 can be operatively supported within tire chamber C in any suitable manner, and can include one or more components supported on or along rim R or other parts of wheel W and/or along tire TR. For example, in the arrangement shown in FIG. 3, sensor 100 is shown as being disposed within tire chamber C and supported along an outside diameter surface of rim R that is oriented toward inner surface ISF of tire body B. Sensor 100 includes a sensor housing 150 that is secured in a suitable manner to the rim R. In the illustrated embodiment, the sensor housing 150 is immovably fixed to rim R and rotates therewith. Alternatively, sensor housing 150 can be movably connected to the rim using a slip ring or other connection that allows relative angular movement between sensor housing 150 and rim R about axis of rotation X such that sensor housing 150 does not rotate with rim R. In this manner, sensor 100 can be continuously operatively directed toward roadway RD. Sensor 100 includes a millimeter wavelength radar source 160 and a millimeter wavelength radar receptor 170. In a preferred arrangement, such as is shown in FIG. 3, radar source 160 and radar receptor 170 are operatively disposed on a common component, such as rim R, and can be located in proximal relation to one another as part of the same component in a single housing (e.g., housing 150), as shown herein, or as part of separate adjacent components. In one embodiment, sensor housing 150 is connected to rim R by an air-tight threaded connection that is accessible from a location that is external to tire chamber C (e.g., along an exposed external surface of rim R outside tire chamber C) that allows sensor 100 to project through rim R into tire chamber C and also allows sensor 100 to be removed and replaced or serviced without requiring removal of tire TR from rim R. However, it will be appreciated that other configurations and/or arrangements could alternately be used without departing from the subject matter of the present disclosure.

Inflation height and contact patch sensor 100 can include a self-contained, rechargeable electrical power source 178 (e.g., one or more batteries) and can also include radio frequency (RF) antenna 104 suitable for wireless reception and/or transmission of signals, data and/or information for communication and/or other purposes. Antenna 104 (or, a second antenna can be included and) can be connected to an optional radio frequency energy harvesting circuit 182 (FIG. 6) used to harvest electrical energy from the received RF energy and provide wireless electrical power to the sensor for direct use and/or to a charging circuit 184, such as for recharging self-contained, rechargeable power source 178. In another embodiment, sensor 100 includes or is connected to an optional vibration energy harvesting device 186 (FIG. 6) connected to rim R (as shown), tire body B, or elsewhere in tire chamber C, tire assembly T, or vehicle V. Vibration energy harvesting device 186 can include any known system for converting kinetic energy in the form of vibration and other movement of tire assembly T into electrical energy for powering sensor 100 directly and/or for charging power source 178. Suitable examples of a vibration energy harvesting device 186 for use according to the present disclosure include a piezo-electric or similar electromechanical transducers that convert mechanical energy from movement into electrical energy and/or electromagnetic energy generators that generate electrical power via electromagnetic induction based upon relative movement between a coil and a magnetic field.

During use, in accordance with the subject matter of the present disclosure, inflation height and contact patch sensors 100 are shown in FIG. 3 as being operable emit to millimeter wave radar waves having a frequency greater than or equal to 120 gigahertz (GHz) and a wavelength of less than or equal to 2.5 millimeters (mm) from radar source 160 in a direction toward a target TG located on and/or provided as part of the tire body inner surface ISF, such as is represented by arrow EMT. In one embodiment, sensor devices 100 transmit radar waves of a frequency inclusively in the range of 120 to 240 gigahertz (GHz), corresponding to a wavelength inclusively in the range of 2.5 to 1.25 millimeters (mm). Target TG can be provided by any part of tire assembly T internal to tire chamber C that is generally spaced-apart from and moveable with respect to radar source 160, such as any part of tire body B and inner surface ISF thereof. Emitted radar waves EMT are incident upon target TG and at least some of the emitted radar waves are then reflected off of the target TG in a direction back toward radar receptor 170, as is represented by arrows RFL. The angle defined between radar receptor 170 (which can include an array of multiple receiver antennae) and received reflected radar waves RFL is referred to as the angle of arrival. Inflation height and contact patch sensor 100 in accordance with the subject matter of the present disclosure will operate properly while reflecting radar waves off any part of inner elastomeric surface ISF or other part of tire body B, without requiring the use of any specialized reflector or coating. In some cases, however, it may be desirable to provide a separate, specialized reflective target TG′ (partially shown in broken lines) connected to inner surface ISF of tire body B or embedded in tire body B, such as a coating, film, or other layer or structure, having predetermined reflective properties, such as may be useful to provide a particular level of performance or robustness of operation. In one embodiment, added target TG′ extends 360 degrees along inner surface ISF of tire body B about axis of rotation X such that part of added target TG′ will always be aligned with sensor 100 regardless of the angular mounting location of tire TR on rim R.

Sensor 100, or a system or component operatively associated with the sensor, can be operable to determine time of flight of the radar waves traveling at the speed of light (i.e., 299,792,458 meters per second (m/s) in air) from radar source 160, to target TG and then to radar receptor 170. It will be appreciated that the roundtrip distance traveled by the radar waves will have a relation to the time of flight. Thus, by determining the time of flight of the radar waves, a distance H′ between radar source 160 and target TG can be determined by processors 106 and/or 136 or by ECU 112 or another processor. When the target TG is provided as tread region inner surface TDi, this distance H′ between radar source 160 and radar receptor 170 is directly related to and varies directly with inflation height H of tire assembly T such that distance H′ (and inflation height H) decreases as air pressure in tire chamber C is reduced (until rim R contacts road surface RD) and distance H′ (and inflation height H) increases to a maximum value when tire TR is fully inflated (until sidewalls S1 and S2 are extended to a maximum height). As noted above, “inflation height” H of tire assembly T is defined as the minimum distance between rim R and roadway RD or other surface on which tire assembly T is operably supported. As such, sensor processor 106 and/or receiver processor 136 and/or ECU 112 and/or other processors can determine and/or assess changes in inflation height H based upon distance H′ measured by sensor 100 and/or changes in distance H′ measured by sensor 100.

Additionally, or in the alternative, inflation height and contact patch sensor 100, or a system or component operatively associated therewith, can be operable to determine a frequency shift or phase shift between radar waves EMT transmitted by radar source 160 and radar waves RFL reflected from target TG and received by radar receptor 170 using pulsed Doppler radar pulses or continuous wave frequency modulation (CWFM) of continuously transmitted radar waves. In either case, it will be appreciated that, based upon the Doppler effect, the frequency shift exhibited by the reflected radar waves RFL relative to transmitted radar waves EMT will have a relation to relative movement between source 160 and target TG. Thus, by determining the time of flight of the radar waves and/or by determining the phase shift of the radar waves, sensor 100, or a system or component operatively associated with sensor 100 (such as processor 106, processor 136, and/or ECU 112), can then determine distance H′ between source 160 and target TG and can also determine the velocity and acceleration of target TG relative to radar source 160. Sensor 100 can be operative to update such measurements rapidly to assess changes over time. Furthermore, sensor 100 can be operative to monitor and assess the angle of arrival or changes in the angle of arrival of reflected radar waves RFL as received by receptor 170. The angle of arrival or changes in the angle of arrival allow sensor processor 106 or receiver processor 136 to determine the angle or changes in the angle between tire inner surface ISF (e.g., as may be at least partially defined by TDi,S1i, and/or S2i) or another target TG and radar receptor 170. Accordingly, inflation height and contact patch sensors 100, or a system or component operatively associated therewith, are operable to determine a distance between, the angle between, velocity difference between, and/or acceleration between radar wave source 160 and target TG.

Additionally, or in the alternative, inflation height and contact patch sensors 100, or a system or component operatively associated therewith, can be operable to determine a distance between, the angle between, velocity difference between, and/or acceleration between radar source 160 and an alternative target located in tire chamber C such as any portion of one or both sidewalls S1 and S2 (e.g., such as sidewall inner surfaces S1i and/or S2i) and/or can be operable to determine a maximum distance defined between first and second sidewalls S1 and S2 across tire chamber C to assess inflation height H or pneumatic pressure contained in tire chamber C.

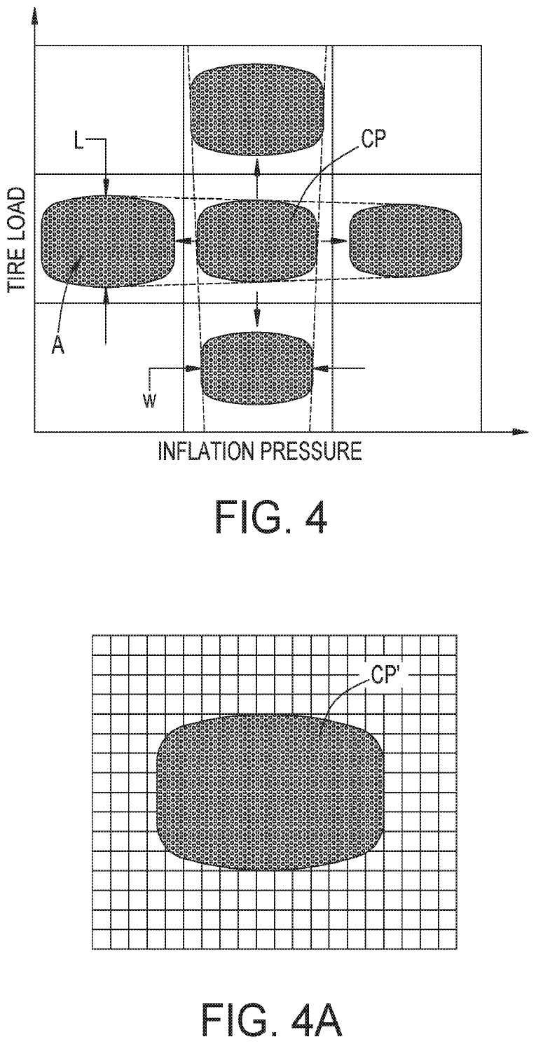

With reference also to FIG. 4, inflation height and contact patch sensors 100, or a system or component operatively associated therewith, are optionally further operable to sense the size of a tire contact patch CP existing between external tread TDX of tire TR and roadway RD or other support surface on which tire TR is supported for rolling movement. FIG. 4 provides a diagram that shows changes in tire contact patch CP size (length (L)×width (W)) in response to variations in tire air pressure and tire load. In particular, as tire inflation pressure increases, length L and width W of contact patch CP (and, thus, its overall size/area A as estimated by its length L multiplied by its width W or as otherwise determined) decrease. Conversely, as tire load increases, length L and width W of contact patch CP (and, thus, its overall size/area A) increase. According to one aspect of the present disclosure, for at least one and preferably for each of tire assemblies T of the vehicle, sensors 100 sense at least one of: (i) length L of contact patch CP; (ii) width W of contact patch CP; (iii) size/area A of contact patch CP. In one example, sensor processor 106, receiver processor 136 and/or ECU 112 uses received reflected radar waves RFL to construct a two-dimensional image CP′ (FIG. 4A) representing contact patch CP based upon the fact that contact patch CP, and the corresponding portion of tread inner surface TDi aligned therewith and adjacent thereto, is flat or otherwise non-cylindrical as compared to the portions of tread TDX and tread inner surface TDi not in contact with road RD or other support surface. Furthermore, the presence of roadway RD adjacent the contact patch affects reflection RFL of the radar waves. Thus, radar waves RFL reflected from the portion of tread inner surface TDi aligned with and adjacent contact patch CP will be distinguishable by sensors 100 from the radar waves reflected from tread inner surface TDi but not aligned with and adjacent contact patch CP. Length L, width W, and/or overall area A of contact patch CP can be derived directly and/or based upon image contact patch CP′. Alternatively or additionally, sensor processor 106, receiver processor 136, and/or ECU 112 uses pattern matching and other image processing methods to compare constructed two-dimensional contact patch image CP′ with stored contact patch images and/or other data that relate respectively to and indicate over-inflation, under-inflation, or over-loading fault conditions and processors 106, 136 and/or 112 determine if contact patch image CP′ (corresponding to and representing the actual contact patch CP sensed by sensors 100) indicates the presence of any such fault condition by way of an image match.

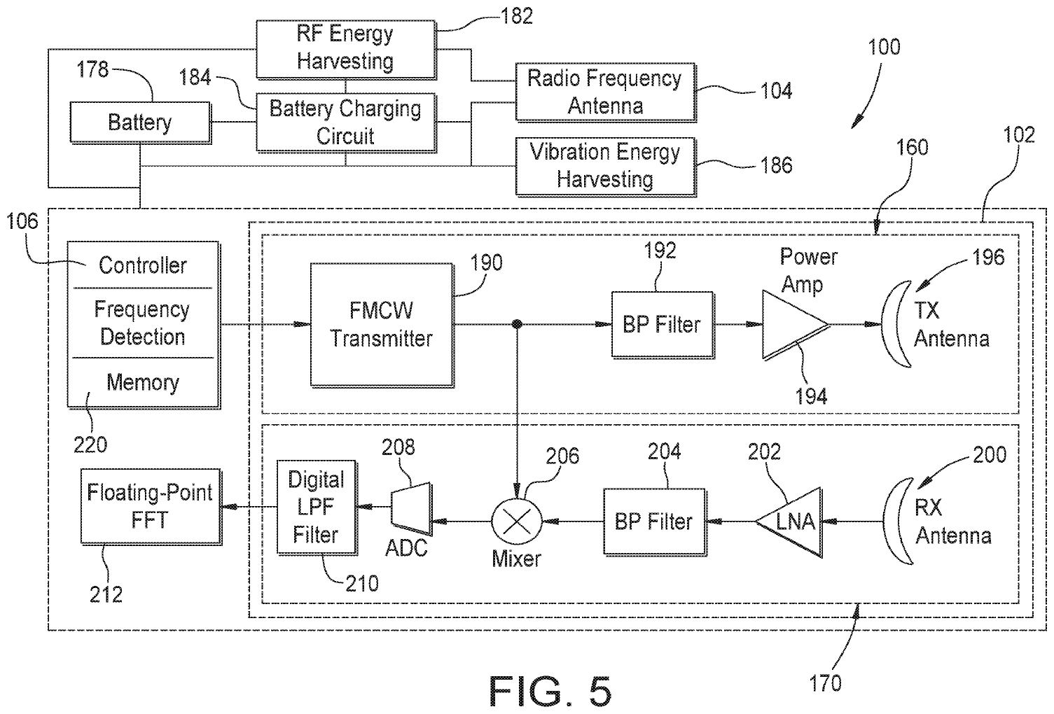

FIG. 5 schematically illustrates one example of an inflation height and contact patch sensor 100 in accordance with the subject matter of the present disclosure. As discussed above, sensors 100 are preferably of a type, kind and/or construction that utilizes millimeter wave radar waves having a frequency (f) inclusively in the range of 120 GHz to 240 GHz (120 GHz f 240 GHz) which corresponds to a wavelength (A) inclusively in the range of 2.5 mm to 1.25 mm (2.5 mm A 1.25 mm) and that utilizes either a pulsed Doppler radar method or a continuous wave frequency modulation method to generate data, signals, information and/or other communications having a relation to a distance, relative velocity, acceleration, and/or angle or change in angle between receiver 170 and target TG.

Sensors 100 include millimeter wave radar source 160 that is operable to emit radar waves through a transmit (TX) antenna 196 toward target surface, such as target TG or any other surface. In the illustrated example, radar source 160 includes a frequency modulated continuous wave transmitter 190 operably connected to a band pass filter 192 that passes signals of the frequency generated by transmitter 190 and a power amplifier 194 which, in turn, outputs emitted radar waves EMT through transmit antenna 196 toward target TG. Sensors 100 also includes a radar wave receptor 170 that is operable to sense, receive, or otherwise detect returned radar waves RFL reflected from the target through a receive (RX) antenna 200 and the angle of arrival of reflected radar waves RFL at receive (RX) antenna 200 which can include an array of multiple antennae. Receive antenna 200 is operably connected to a low noise amplifier 202 which outputs the amplified signal to a band pass filter 204.

An RF mixer 206 is operably connected to and receives input signals from band pass filter 204 and also the originally generated FMCW signal from frequency modulated continuous wave transmitter 190. Mixer 206 outputs a signal that represents the phase shift or phase difference between originally-transmitted radar FMCW signal EMT and received reflected signal RFL. RF mixer 206 is operably connected to and outputs the phase difference signal to an analog-to-digital converter (ADC) 208 which outputs the digital signal to a low pass filter 210 for conditioning the signal to remove undesired high-frequency noise. Low-pass filter 210 is operably connected to a Fast Fourier Transform (FFT) module 212 that performs a Fast Fourier Transform on the signal to obtain the desired frequency phase-shift data which are input to microprocessor 106 or another electronic controller, which can alternatively be receiver processor 136 of receiver module 130, ECU 112, and/or another microprocessor or other controller provided as part of system S and/or vehicle V. Processor 106 (or another electronic controller) derives height H′ and relative velocity and/or acceleration between transmit antenna 196 and target TG. Processors 106 and 136 and ECU 112 can be of any suitable type, kind and/or configuration, such as a microprocessor, for example, for processing data, executing software routines/programs, and other functions relating to at least the determination of the time of flight, frequency phase shift, and angle of arrival or changes in the angle of arrival for reflected radar waves RFL received by RX antenna 200. Additionally, sensors 100 can be communicatively coupled with other systems and/or components (e.g., controller 112 in FIG. 1) in any suitable wired or wireless manner.

Additionally, processor 106 or other part of sensors 100 can include a non-transitory storage device or memory 220, which can be of any suitable type, kind and/or configuration that can be used to store data, values, settings, parameters, inputs, software, algorithms, routines, programs and/or other information or content for any associated use or function, such as used in association with the determination of the time of flight and frequency phase shift occurring between the transmitted radar waves and the reflected radar waves received via RX antenna 200 and/or for determining the angle of arrival of reflected radar waves RFL at RX antenna 200. Non-transitory memory 220 is operably communicatively coupled with processor 106 such that the processor can access the memory to retrieve and execute any one or more software programs and/or routines. Additionally, data, values, settings, parameters, inputs, software, algorithms, routines, programs, stored contact patch images for pattern matching, and/or other information or content can also be retained within memory 220 for retrieval by processor 106. It will be appreciated that such software routines can be individually executable routines or portions of a software program, such as an operating system, for example. Additionally, it will be appreciated that the controller, processing device and/or memory, can take any suitable form, configuration and/or arrangement, and that the embodiments shown and described herein are merely exemplary. Furthermore, it is to be understood, however, that the modules described above in detail can be implemented in any suitable manner, including, without limitation, software implementations, hardware implementations or any combination thereof.

Using such an arrangement, tire inflation height and contact patch sensors 100 can function as an extremely accurate sensor that is capable of providing signals, data and/or other information regarding tire inflation height H, velocity and acceleration of a target TG portion of tire body B relative to sensor 100, tire contact patch CP size & shape, and the angle or changes in the angle between target TG and sensor 100. This information can be used by other vehicle systems such as warning systems, ride control or handling systems, vibration control and active damping systems, and system that utilize road surface information such as active suspension systems or active engine mounts. Sensor 100 disclosed herein enable an accuracy of +/−1 millimeter increments to be achieved for distance/height measurements, with both measurements updated with new measurements at an update rate of less than 1 millisecond. In one embodiment, the displacement and velocity measurements are updated with new measurements every 700 microseconds.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus, it is to be distinctly understood claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. A tire assembly comprising:
a tire including a tire body with a cylindrical tread region and axially-spaced first and second sidewalls extending radially inward to respective first and second mounting beads that at least partially define a central opening of said tire body, said tire body including an inner surface with a tread region inner surface portion disposed axially between said first and second sidewalls, said cylindrical tread region including an exterior tread adapted to roll along an associated road surface, and said cylindrical tread region together with said first and second sidewalls at least partially defining an annular tire chamber with an open end in communication with said central opening of said tire body;
a tire height and contact patch sensor at least partially disposed within said annular tire chamber and supported radially inward of said tread region inner surface portion of said tire body, said sensor including:
an electrical power source;
a radar source communicatively coupled with said electrical power source and operable to emit millimeter wavelength radar waves into said annular tire chamber toward a target area along said inner surface of said tire body;
a radar receptor communicatively coupled with said electrical power source and operable to receive millimeter wavelength radar waves reflected off of said target area along said inner surface of said tire body and generate a signal having a relation to said reflected radar waves and/or receipt of said reflected radar waves; and,
an antenna communicatively coupled with at least said radar receptor and operable to transmit data, signals and/or communications having said relation to said reflected radar waves and/or receipt of said reflected radar waves to an associated system external to said annular tire chamber; and,
a processor communicatively coupled with at least one of said radar source, said radar receptor and said antenna, said processor operable to determine a distance between said radar source and said target area based on at least one of: (i) a time of flight required for said radar waves to travel from said radar source to said target area and then to said radar receptor; (ii) a frequency phase shift between said radar waves transmitted by said radar source and said radar waves reflected from said target area and received by said radar receptor.

2. A tire assembly according to claim 1, wherein said processor is further operable to determine at least one of velocity and acceleration of relative movement between said radar source and said target area based upon a frequency phase shift between said radar waves transmitted by said radar source and said radar waves reflected from said target area and received by said radar receptor.

3. A tire assembly according to claim 1, wherein said radar source is operative to emit at least one of: (i) individual pulses of radar waves; (ii) a continuous radar wave that is frequency modulated.

4. A tire assembly according to claim 1, wherein said radar source emits said millimeter wave radar waves with a frequency greater than or equal to 120 gigahertz (GHz) and a wavelength of less than or equal to 2.5 millimeters (mm) toward said target area.

5. A tire assembly according to claim 1, wherein said processor determines said distance at a resolution of less than or equal to one (1) millimeter increments.

6. A tire assembly according to claim 1, wherein said processor determines said distance repeatedly at intervals of less than or equal to one (1) millisecond.

7. A tire assembly according to claim 1 further comprising a vibration energy harvesting device operable to convert kinetic energy from movement of said tire assembly into electrical energy, said vibration energy harvesting device communicatively coupled with said radar source and operable to provide electrical power thereto.

8. A tire assembly according to claim 7, wherein said electrical power source is rechargeable and said vibration energy harvesting device is operably connected to said electrical power source to supply recharging electrical power thereto.

9. A tire assembly according to claim 1, wherein said electrical power source of said sensor includes a radio frequency energy harvesting circuit for harvesting electrical energy from radio frequency waves received by said antenna.

10. A tire assembly according to claim 9, wherein said electrical power source is rechargeable and said radio frequency energy harvesting circuit is operably connected to said electrical power source to supply recharging electrical energy thereto.

11. A tire assembly according to claim 1, wherein said processor is operable to determine an angle between said target area and said radar receptor based upon an angle of arrival at which said radar waves reflected from said target area are received at said radar receptor.

12. A tire assembly according to claim 1, wherein said processor at least partially disposed within said annular tire chamber, and said sensor includes said processor.

13. A tire assembly according to claim 1, wherein said processor is external to said annular tire chamber.

14. A tire assembly according to claim 1, further comprising a rim adapted for displacement about an axis of rotation, said rim including a rim wall with said tire body mounted on said rim such that at least a portion of said inner surface of said tire body faces radially inward toward a portion of said rim wall with said sensor supported along said portion of said rim wall.

15. A vehicle system comprising:
an electronic control system;
at least one tire assembly according to claim 1 in operative communication with said electronic control system.

16. A tire assembly according to claim 1, wherein said tire includes a contact patch generated during use, and said processor is operable to determine one or more of a length, a width, and an area of said contact patch based on at least one of: (i) a time of flight required for said radar waves to travel from said radar source to said target area and then to said radar receptor; (ii) a frequency phase shift between said radar waves transmitted by said radar source and said radar waves reflected from said target area and received by said radar receptor.

17. A tire assembly comprising:
a rim adapted for displacement about an axis of rotation, said rim including a rim wall with an outer peripheral surface portion;
a tire including a tire body with an outer tread region, axially-spaced first and second sidewalls, an inner surface that at least partially defines an annular tire chamber with a tread region inner surface portion disposed between said first and second sidewalls, said tire mounted on said rim such that said outer peripheral surface portion of said rim wall is disposed in facing relation to said tread region inner surface portion;
a tire height and contact patch sensor supported on said outer peripheral surface portion of said rim wall within said annular tire chamber, said sensor including:
an electrical power source;
a radar source communicatively coupled with said electrical power source and operable to emit millimeter wavelength radar waves into said annular tire chamber toward a target area along said inner surface of said tire body;
a radar receptor communicatively coupled with said electrical power source and operable to receive millimeter wavelength radar waves reflected off of said target area along said inner surface of said tire body and generate a signal having a relation to said reflected radar waves and/or receipt of said reflected radar waves; and,
an antenna communicatively coupled with at least said radar receptor and operable to transmit data, signals and/or communications having said relation to said reflected radar waves and/or receipt of said reflected radar waves to an associated system external to said annular tire chamber; and,
a processor communicatively coupled with at least one of said radar source, said radar receptor and said antenna, said processor operable to determine a distance between said radar source and said target area based on at least one of: (i) a time of flight required for said radar waves to travel from said radar source to said target area and then to said radar receptor; (ii) a frequency phase shift between said radar waves transmitted by said radar source and said radar waves reflected from said target area (TG) and received by said radar receptor.

18. A tire assembly according to claim 17, wherein said tire includes a contact patch, and said processor is operable to determine one or more of a length, a width, and an area of said contact patch based on at least one of: (i) a time of flight required for said radar waves to travel from said radar source to said target area and then to said radar receptor; (ii) a frequency phase shift between said radar waves transmitted by said radar source and said radar waves reflected from said target area and received by said radar receptor.

19. A tire assembly according to claim 18, wherein said processor is operable to generate a two-dimensional image of said tread region inner surface portion of said tire body along said contact patch and compare said two-dimensional image of said contact patch with one or more stored contact patch images representing a corresponding physical condition of said tire.

20. A tire assembly according to claim 17, wherein said processor is operable to determine at least one of velocity and acceleration of relative movement between said radar source and said target area based on at least one of: (i) a time of flight required for said radar waves to travel from said radar source to said target area and then to said radar receptor; (ii) a frequency phase shift between said radar waves transmitted by said radar source and said radar waves reflected from said target area and received by said radar receptor.
